(19) United States
(12) Patent Application Publication
(10) Pub. No.: US 2023/0003417 A1
(43) Pub. Date: Jan. 5, 2023

(54) SYSTEM FOR ATTACHMENT OF AC UNIT VENTS TO CASEMENT OR AWNING WINDOWS

(71) Applicants: Barbara Lynn LOCK, Orillia (CA); Jonathan Neil LOCK, Orillia (CA)

(72) Inventors: Barbara Lynn LOCK, Orillia (CA); Jonathan Neil LOCK, Orillia (CA)

(21) Appl. No.: 17/363,553

(22) Filed: Jun. 30, 2021

(51) Int. Cl. F24F 13/18; F24F 1/028

(52) U.S. Cl. CPC F24F 13/18; F24F 1/028; F24F 2221/20

(57) ABSTRACT

The embodiments of the invention relate to a transparent panel or window insert of corresponding shape and size to a casement or awning window. The transparent panel or window insert is attached to the frame of a casement or awning window or an insect screen by way of a series of releasable fasteners around the outer perimeter of the transparent panel or window insert. A void, corresponding to the shape and size of a A/C hose is cut into the transparent panel or window insert. In some embodiments of the invention the void may be bayoneted to cooperate with bayonette-style hose connections.

### FIELD OF THE INVENTION

The present invention relates generally to the field of an attachment system for portable AC units, specifically to attachment systems for casement, crank or awning type windows, more specifically to attachment system for hoses or vents for portable AC units to casement, crank or awning type windows.

### BACKGROUND

Any discussion of the related art throughout the specification should in no way be considered as an admission that such related art is widely known or forms part of common general knowledge in the field.

DE Pat. Appl. 102009050414 (Dorow) discloses a device for use as a holder for exhaust gas hose of mobile room air-conditioning device. The device has a transparent disk adapted to a size of a window opening or a door opening, where the disk has a partially covered passage opening for airflow. A fastening unit attaches an air hose at the passage opening, and another fastening unit attaches the device at a frame of a door or a window.

CA Pat. Appl. 2,790,553 (Sourtzis) discloses a glass insert for awning or casement window to allow for the use of an air conditioner. Tempered glass insert for awning or casement style window opening to allow for the use of an air conditioner in a room. Dimensions can vary depending on window opening size. Diameter of opening for a/c vent hose to vary depending on a/c hose size and model of air conditioner used. The glass insert is to be placed in same spot where typical screen is placed.

CA Pat. No. 3,042,569 (Pemberton) discloses a replacement window panel with an air conditioner coupling. The window replacement panel including an air conditioning vent incorporated into it. The window assembly may be attached to a decorative panel with a vent disposed on a first side, and a coupling for an AC duct on an opposite side. The window may be a single, double pane, insulated, uninsulated or the like. The panel may be clad with material to harmonize with the building exterior, and the exterior vent presents a pleasing appearance. The combination of window and panel may be sized to replace an existing window, or may be used in new construction.

DE Pat. No. 4,437,849 (Ustrabowski) discloses an insert for a window with one or more rotating and/or tilting casements. The window insert has a panel mounted in the frame of at least one of the rotating or tilting casements of a window. The panel has a flange on its inside, to which equipment hoses can be fitted. The plate designed in this way is attached to place the usual glass insert in the window sash or casement is mounted.

WO Pat Appl. 2015/115,929 (Vasilevich) discloses a method for installing a window air-conditioning unit. The method can be used for the temporary installation of air-conditioning units and other units in windows. The task is achieved by the ability to temporarily install a window conditioner and allowing to prevent damage to the window frame, a device is created that uses a panel with fixing devices to hold it,

EP Pat No. 2,199,525 (Keyace) discloses a cover for a tilted or opened window. In a preferred embodiment, the opening is designed as a slot. This has the advantage that inserting the exhaust hose into the slot in easier. It can be introduced and that the slot closes automatically after the exhaust hose has been removed again. A hook-and-eye connection is used to attach the cover to the casement.

FR Pat. No. 3,013,808 (Duquenois) discloses a device for the exhaust of hot air from a mobile air conditioner. This adapter is compatible with all mobile air conditioner drain pipes thanks to its gradient to adapt to any size of outlet pipe. The invention comprises a plexiglass transparent window aiming to fill the window to have no opening causing yield losses. On this window are present a machined hole to include the adapter and two reinforcements, one machined so as to block the panel with the window leaf having the handle.

U.S. Pat. No. 6,564,512 (Whittemore) discloses a mount for air moving device. A mounting system includes a temporary panel that can be quickly and easily installed at an installation site, for example a window, for rapid installation of an air moving system. The mount comprises a panel having an aperture. An aperture is provided in the panel to allow for the mounting of an air moving device or air duct at the panel. A window panel is installed at a window in a room. An air moving device is coupled to a first end of an air duct. The air duct may comprise a flexible, aluminum or plastic air duct.

U.S. Pat. No. 4,081,915 (Materniak) discloses an exhaust for a laundry dryer. An exhaust system for home appliances requiring outside venting, such as a portable laundry dryer, which obviates the necessity of piercing an exterior wall to vent the appliance to the outside. The system includes a transparent window insert plate assembly, removably insertable within a window opening and having an exhaust outlet and a flexible air hose having means at both ends to removably connect the same with the air outlet of a laundry dryer and with the exhaust outlet of the window insert plate assembly.

U.S. Pat. No. 10,689,901 (O'Leary) discloses a portable window insert for utility distribution. The portable window insert that can be adjusted to fit into the window and distribute utilities, e.g., electricity, from one side of the window to the other side of the window.

All documents cited herein are incorporated by reference.

None of the above cited documents, alone or in combination satisfy the need for a system that facilitates the installation of mobile air conditioner units to exhaust hot air without making contact with or damage to window frames.

### BRIEF SUMMARY

It is an object of the invention to provide a system for attachment of AC unit vents to casement or awning windows.

In accordance with an aspect of the invention there is provided a window insert, for installation in a casement or awning window, said window insert comprising: a transparent panel having a perimeter and being sized and configured to attach to a frame of said casement or awning window, or an insect screen installed in said casement or awning window; a plurality of releasable fasteners positioned at intervals around said perimeter of said transparent panel; and a void cut out of said transparent panel, said void being sized and configured to cooperated with a vent hose of an mobile or stand-up A/C unit.

In accordance with another aspect of the invention there is provided a kit for installing a mobile or stand-up A/C unit in a casement or awning window, said kit comprising: a transparent panel having a perimeter and being sized and configured to attach to a frame of said casement or awning window or an insect screen installed in said casement or awning window; a void cut out of said transparent panel, said void being sized and configured to cooperated with a vent hose of an mobile or stand-up A/C unit, and a plurality of releasable fasteners.

In accordance with an additional aspect of the invention there is provided a method of installing a transparent window insert having A/C hose void in a casement or awning window, said window having a framed insect screen, said method comprising: affixing a plurality of releasable fasteners positioned at intervals around perimeter of said transparent window insert or said frame of said insect screen; positioning said transparent window insert against said frame of said insect screen, said transparent window insert being sized and configured to correspond with said frame of said insect screen; attaching said transparent window insert to said frame of said insect screen via said plurality of releasable fasteners; and connecting an A/C hose to said A/C hose void in said transparent window insert.

The advantages and features of the present invention will become better understood with reference to the following more detailed description and claims taken in conjunction with the accompanying drawings in which like elements are identified with like symbols.

### BRIEF DESCRIPTION OF THE DRAWINGS

To easily identify the discussion of any particular element or act, the most significant digit or digits in a reference number refer to the figure number in which that element is first introduced.

FIG. 1 illustrates a rear aspect of the subject matter in accordance with one embodiment of the invention.

FIG. 2 illustrates a rear aspect of the subject matter in accordance with one embodiment of the invention.

FIG. 3 illustrates an exploded aspect of the installation of the subject matter in accordance with another one embodiment of the invention.

FIG. 4 illustrates an aspect of the subject matter after installation in accordance with one embodiment of the invention.

FIG. 5 illustrates a rear aspect of the subject matter in accordance with an alternative embodiment of the invention.

FIG. 6 illustrates a rear aspect of the subject matter in accordance with a further embodiment of the invention.

FIG. 7 illustrates an exploded aspect of the installation accordance with one embodiment of the invention.

FIG. 8 illustrates an aspect of the subject matter after installation in accordance with one embodiment of the invention.

### DETAILED DESCRIPTION

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

The embodiments of the invention described in detail below relate to a transparent panel or window insert of corresponding shape and size to a casement or awning window. The transparent panel or window insert is attached to the frame of an insect screen by way of a series of releasable fasteners around the outer perimeter of the transparent panel or window insert. A void, corresponding to the shape and size of a A/C hose is cut into the transparent panel or window insert. In some embodiments of the invention the void may be bayoneted to cooperate with bayonette-style hose connections.

The transparent panel or window insert allows the use of mobile or stand-up air conditioners in crank style and awning windows. It is easy to install and allows an unobstructed outside view. The hose connecting directly into the transparent panel or window insert. The ability of being able to directly clip the hose into the window insert allows a cost effective way to cool rooms in most newer builds. Most newbuilds only have the crank-style or awning windows. Embodiments of this invention will allow many who do not have sliding windows to take advantage of the mobile or standup A/C units.

The transparent panel or window insert may be fabricated from various plastics, for example polymethyl methacrylate (PMMA), polycarbonate (PC), polyethylene terephthalate (PET), polyethersulfone (PES), etc. Furthermore, the transparent panel or window insert can be coated, for example, have a coating acting as an infrared filter or infrared reflector for thermal insulation coating.

The transparent panel or window insert is placed in same spot where the insect screen is located. For high rise and residential, commercial or industrial circumstances where an awning or casement window is used it eliminating the need to use just a sliding window in conjunction with mobile stand-up A/C units. The A/C hose is place in a void in the transparent panel or window insert. The awning or casement is opened all the way, and the A/C then vents through the window opening through the insect screen. This allows for the A/C to vent out of the awning or casement opening. In winter months when A/C is not needed, the transparent panel or window insert is removed.

The system described herein makes it possible to install air-conditioning units in casement and awning window apertures without causing any damage whatsoever to window frames and walls. The method makes it possible to install air-conditioning units only for the period for which the latter are required in the hot season and to remove them when they are not required. The installation and removal of the transparent panel or window insert is simple and does not require a high level of expertise.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

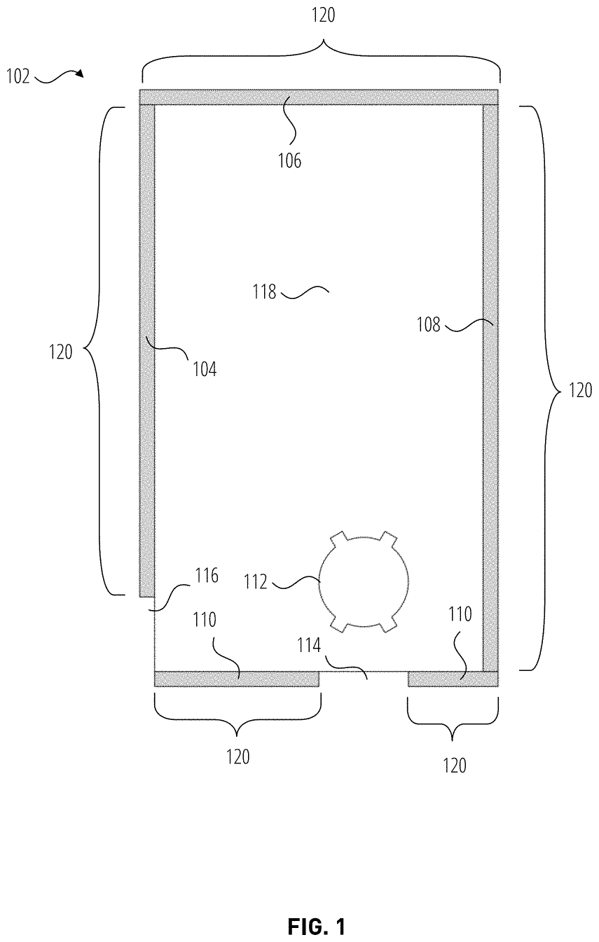

FIG. 1 shows a rear view of the window insert 102 in accordance with one embodiment of the invention that is configured to attach directly to the fixed frame portion of a casement window.

The window insert 102 comprises a transparent sheet 118, including but not limited to polymethyl methacrylate (PMMA); polycarbonate (PC); polyethylene terephthalate (PET); polyethersulfone (PES); acrylic; and Perspex™. The transparent sheet 118 having an edge or frame around its outer perimeter.

The window insert 102, typically comprises a first side of frame 104, a top of frame 106, a second side of frame 108 and a bottom of frame 110.

The transparent sheet 118 has void removed that forms an A/C hose attachment point 112 at a suitable position on the transparent sheet 118. In the illustrated embodiment of the invention, the A/C hose attachment point 112 is configured to engage with a bayonetted AC hose attachment member. Other shapes of A/C hose attachment point 112 known to workers in the field are also considered to be within the scope of protection sought. Additional voids in the transparent sheet 118 may also be formed, again at suitable positions, to accommodate a crank handle opening 114 and a window locking opening 116.

A means of attaching the window insert 102 into position in a window frame is provided around the edges or frame of the transparent sheet 118. The means of attaching the window insert 102 into position typically comprises an adhesive layer 120 that provides a removable or releasable attachment to the fixed frame of the casement. The adhesive layer 120 can be selected from the group including, but not limited to: double sided sticky tape; double sided sticky foam pads or tape; and hook and loop fasteners such as Velcro™.

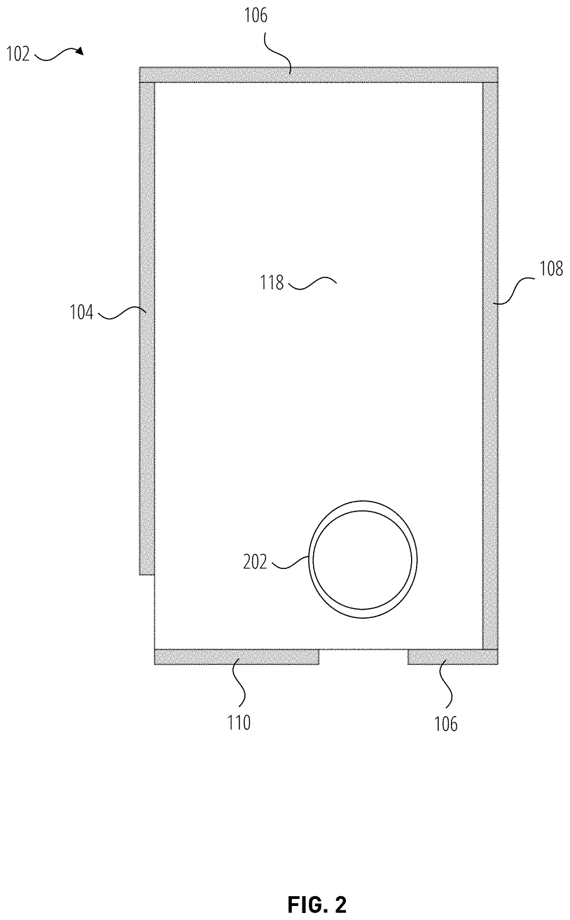

FIG. 2 shows a rear view of the window insert 102 in accordance with one embodiment of the invention.

In this illustration, a sealing gasket 202 can be seen installed in the transparent sheet 118 around the A/C hose attachment point 112. The optional sealing gasket 202 functions to prevent leaks around the A/C hose attachment point 112 and the transparent sheet 118.

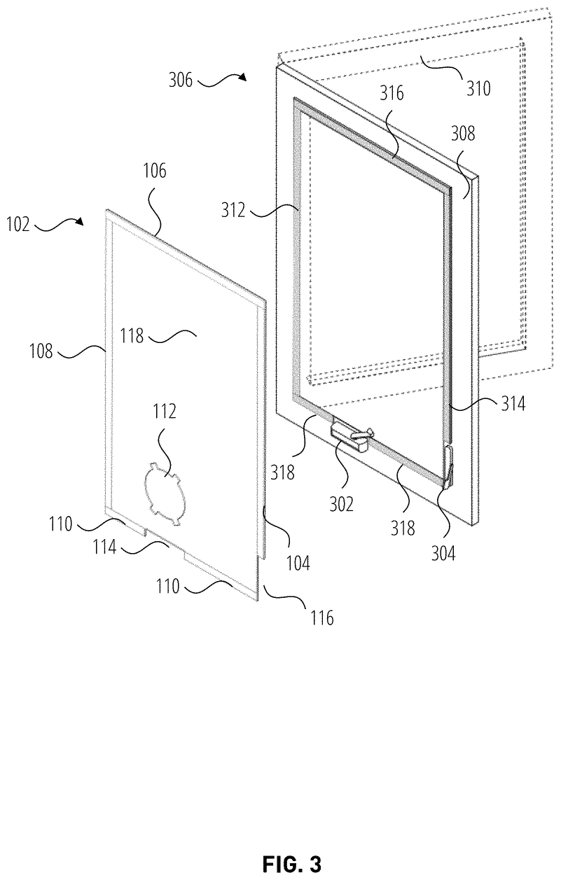

FIG. 3 shows an embodiment of the window insert 102 of the present invention.

A casement window 306 can be seen having a casement window frame 308 and an opened casement window 310.

The fixed portion of the casement window frame 308 has frame comprising a second side of attachment 312, a first side of attachment 314, a top portion of attachment 316 and a bottom portion of attachment 318. Indentations in the casement window frame 308 can be seen to accommodate the crank handle 302 and the locking mechanism 304 of the casement window 306.

A front view of the window insert 102 can be seen having the same features as shown in FIG. 1 and FIG. 2. The adhesive layers 120, on the rear surface of the transparent sheet 118, cannot be seen in this illustration.

The dimensions of the window insert 102, including the positioning of the voids to accommodate the crank handle 302 and the locking mechanism 304, essentially correspond to the dimensions of the casement window frame 308.

Installation of the window insert 102 into the casement window 306 is achieved by affixing the adhesive layer 120 (not shown) on the outer edges or frame of the window insert 102 and engaging them with the casement window frame 308. Essentially: the first side of frame 104 attaches to the first side of attachment 314 of the casement window frame 308; the second sides of frame 108 attaches to the second side of attachment 312 of the casement window frame 308; the top of frame 106 attaches to the top portion of attachment 316 of the casement window frame 308; and the bottom of frame 110 attaches to the bottom portion of attachment 318 of the casement window frame 308. The crank handle opening 114 on the window insert 102 corresponds to the crank handle 302 and the window locking opening 116 corresponds to the locking mechanism 304.

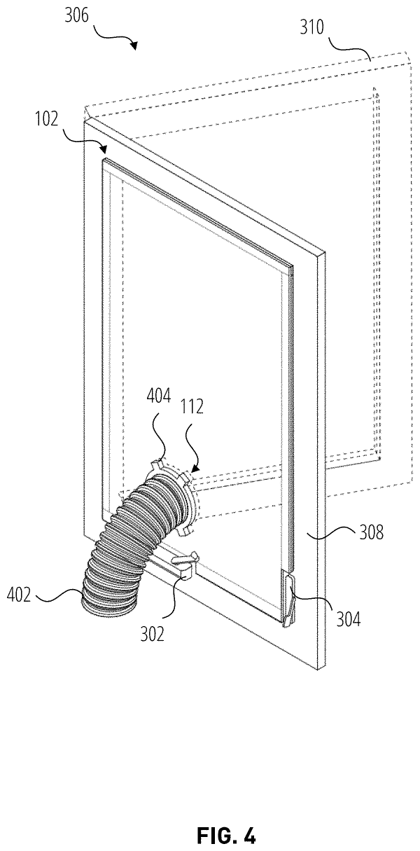

FIG. 4 shows a view of an opened casement window 310 with an embodiment of the window insert 102 of the invention installed in the casement window frame 308.

The casement window 306 has a crank handle 302, and a locking mechanism 304. The window insert 102 of an embodiment of the invention is affixed to the frame of the casement window frame 308 as previously described.

A bayoneted attachment 404 of an A/C hose 402 can be seen in functional cooperation with the A/C hose attachment point 112 of the window insert 102.

The adhesive layer 120 is present on either the edge or frame of the window insert 102 or the casement window frame 308 or both, cannot be seen.

In some embodiments of the invention, the means of attaching the window insert 102 to the casement window frame 308 may be by way of a variety of releasable fasteners. These releasable fasteners may be opposing sections of sticky-backed hook and loop fasteners, attached to corresponding sections to the window insert 102 and casement window frame 308. These releasable fasteners may also be opposing cooperating sections of pop rivets or push/friction fit clips.

Other fasteners for repeated uses may include various non-mechanical fasteners such as 3M Dual Lock™. These are lightweight and flexible enough for repeated use offering durable attachment. These, and other similar, fasteners offer weight reduction and time savings during installation versus traditional mechanical fasteners such as screws, nuts and bolts.

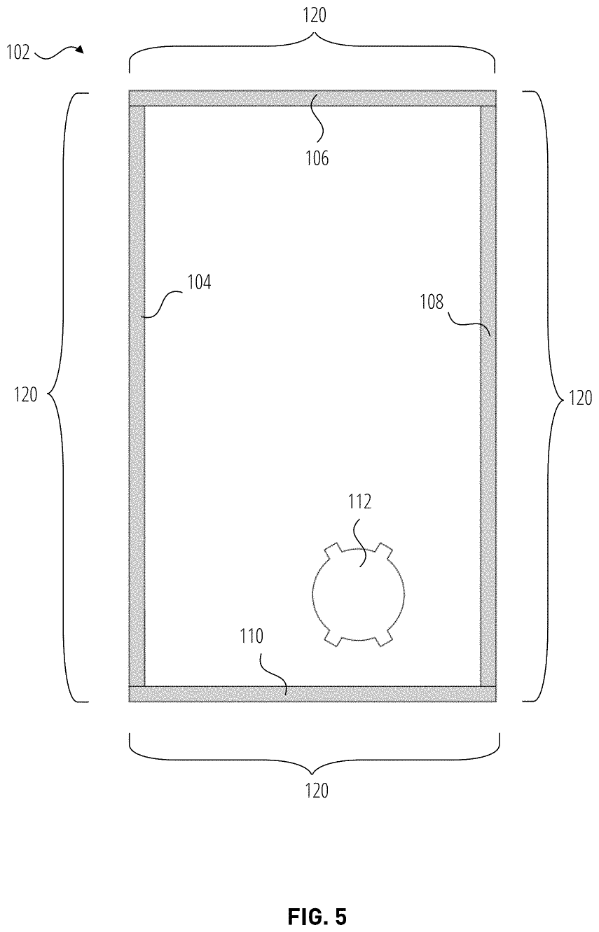

FIG. 5 shows a rear view of the window insert 102 in accordance with one embodiment of the invention that is configured to attach to the frame portion of an insect screen that is fitted into a casement window frame 308.

The window insert 102 comprises a transparent sheet 118, including but not limited to acrylic and Perspex™. The transparent sheet 118 having an edge or frame around its outer perimeter.

The window insert 102, typically comprises a first side of frame 104, a top of frame 106, a second side of frame 108 and a bottom of frame 110.

The transparent sheet 118 has void removed that forms an A/C hose attachment point 112 at a suitable position on the transparent sheet 118. In the illustrated embodiment of the invention, the A/C hose attachment point 112 is configured to engage with a bayonetted AC hose attachment member. Other shapes of A/C hose attachment point 112 known to workers in the field are also considered to be within the scope of protection sought. Additional voids in the transparent sheet 118 may also be formed, again at suitable positions, to accommodate a crank handle opening 114 and a window locking opening 116.

A means of attaching the window insert 102 into position onto the frame of an insect screen is provided around the edges or frame of the transparent sheet 118. The means of attaching the window insert 102 into position typically comprises an adhesive layer 120 that provides a removable or releasable attachment to the fixed frame of the casement. The adhesive layer 120 can be selected from the group including, but not limited to: double sided sticky tape; double sided sticky foam pads or tape; and hook and loop fasteners such as Velcro™.

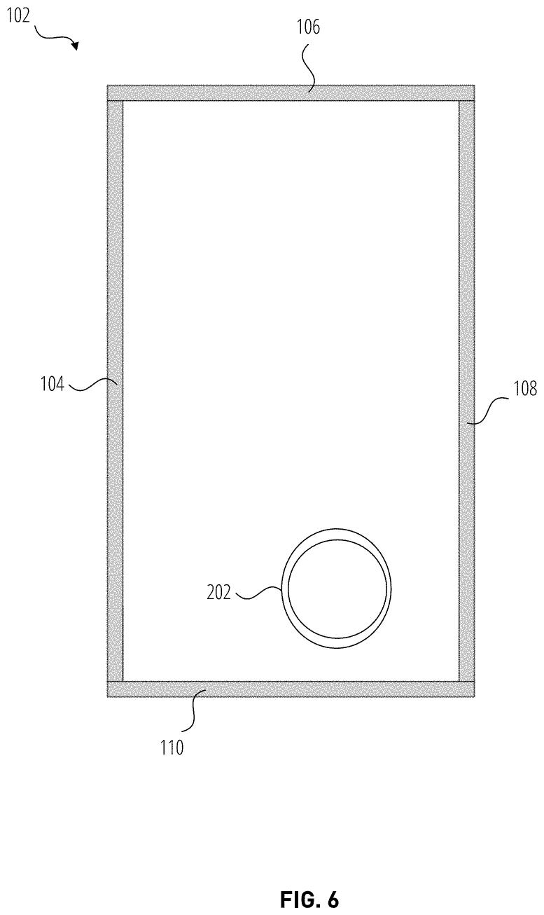

FIG. 6 shows a rear view of the window insert 102 in accordance with an embodiment of the invention for use with an insect screen.

In this illustration, a sealing gasket 202 can be seen installed in the transparent sheet 118 around the A/C hose attachment point 112. The optional sealing gasket 202 functions to prevent leaks around the A/C hose attachment point 112 and the transparent sheet 118.

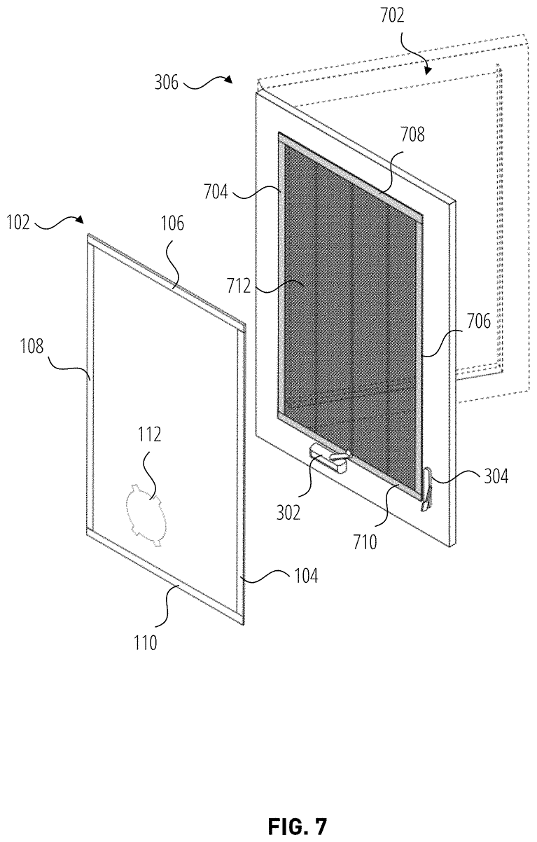

FIG. 7 shows an embodiment of the window insert 102 of the present invention that is configured to attach to the frame portion of an insect screen that is fitted into a casement window frame 308.

A casement window 306 can be seen having a casement window frame 308 and an opened casement window 310. The casement window 306 has an insect screen 712 mounted into the casement window frame 308 by conventional means.

The insect screen 712 has frame comprising a second side of insect frame 704, first side of insect screen 706, a top of insect screen 708 and a bottom of insect screen 710.

A front view of the window insert 102 can be seen having the same features as shown in FIG. 5 and FIG. 6. The adhesive layers 120, on the rear surface of the transparent sheet 118, cannot be seen in this illustration.

The dimensions of the window insert 102, essentially corresponds to the dimensions of the insect screen 712.

Installation of the window insert 102 into the casement window 306 is achieved by affixing the adhesive layer 120 (not shown) on the outer edges or frame of the window insert 102 and engaging them with the frame of the insect screen 712. Essentially: the first side of frame 104 attaches to the first side of insect screen 706; the second side of frame 108 attaches to the second side of insect frame 704, the top of frame 106 attaches to the top of insect screen 708 and the bottom of frame 110 attaches to the bottom of insect screen 710.

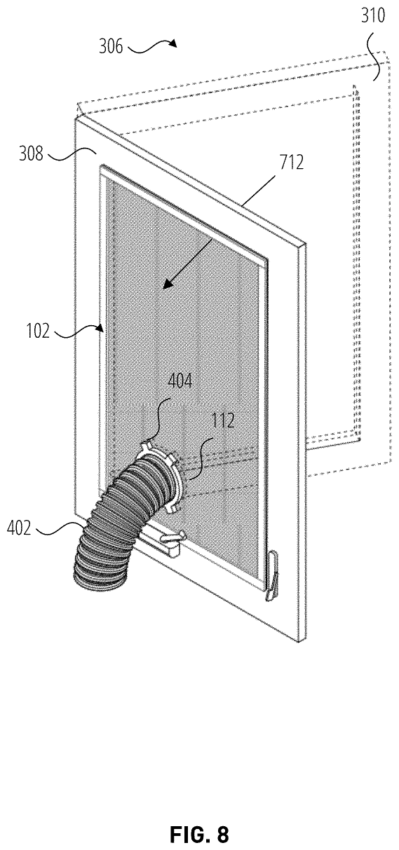

FIG. 8 shows a view of an opened casement window 310 with an embodiment of the invention that is attached to the frame portion of an insect screen that is fitted into a casement window frame 308.

A bayoneted attachment 404 of an A/C hose 402 can be seen in functional cooperation with the A/C hose attachment point 112 of the window insert 102.

The adhesive layer 120 is present on either the edge or frame of the window insert 102, or the interior facing or first surface of the frame of an insect screen 712, or both, cannot be seen.

In some embodiments of the invention, the means of attaching the window insert 102 to the frame of the insect screen 712 may be by way of a variety of releasable fasteners. These releasable fasteners may be opposing sections of sticky-backed hook and loop fasteners, attached to corresponding sections to the window insert 102 and frame of the insect screen 712. These releasable fasteners may also be opposing cooperating sections of pop rivets or push/friction fit clips.

Other fasteners for repeated uses may include various non-mechanical fasteners such as 3M Dual Lock™. These are lightweight and flexible enough for repeated use offering durable attachment. These, and other similar, fasteners offer weight reduction and time savings during installation versus traditional mechanical fasteners such as screws, nuts and bolts.

In some embodiments of the invention, the window insert 102 may be tinted, for example with a window darkening film. In other embodiments, just the lower portion of the window insert 102 may be tinted. The latter embodiment specifically being designed to prevent sunlight from entering the lower portion of the window when a blind has been lowered down to the top of the A/C hose 402.

The method of installation of the window insert 102 includes the following steps:

The interior or first facing edge of the frame of the casement window frame 308 or insect screen 712 is cleaned to remove oils, grease and particulate matter.

The outer facing edge, or frame, of the window insert 102 is similarly cleaned to remove oils, grease and particulate matter.

The releasable fasteners that are being used to attach the window insert 102 to the casement window frame 308 or insect screen 712 are selected.

The selected releasable fasteners are applied to either the interior facing edge of the frame of the casement window frame 308 or insect screen 712, or outer facing edge or frame of the window insert 102.

The window insert 102 is then affixed in place on the frame of the casement window frame 308 or insect screen 712.

The A/C hose 402 is then attached to the A/C hose attachment point 112.

The casement window 306 is opened and the A/C unit switched on.

The embodiments of the invention as described herein relate to the use of the window insert 102 in casement windows 306. A worker skilled in the art would readily appreciate that the embodiments of the invention can also function in a similar manner in awning windows, which are also therefore considered to be within the scope of protection sought.

Similarly, the window insert 102 can be used to vent other heat or moisture producing appliances through casement or awning windows, such as tumble driers.

The foregoing descriptions of specific embodiments of the present invention have been presented for purposes of illustration and description. They are not intended to be exhaustive or to limit the invention and method of use to the precise forms disclosed. Many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

We claim:

1. A window insert, for installation in a casement or awning window, said window insert comprising:
a transparent panel having a perimeter and being sized and configured to attach to a frame of said casement or awning window, or an insect screen installed in said casement or awning window;
a plurality of releasable fasteners positioned at intervals around said perimeter of said transparent panel; and
a void cut out of said transparent panel, said void being sized and configured to cooperated with a vent hose of a mobile or stand-up A/C unit.

2. The window insert of claim 1, wherein a panel frame surrounds said perimeter of said transparent panel.

3. The window insert of claim 2, wherein said plurality of releasable fasteners are attached to said panel frame.

4. The window insert of claim 1, having one or more additional voids cut out of said transparent panel, said one or more additional voids corresponding in shape and size to a crank handle and locking mechanism of said window.

5. The window insert of claim 2, having one or more additional voids cut out of said panel frame of said transparent panel, said one or more additional voids corresponding in shape and size to a crank handle and locking mechanism of said window.

6. The window insert of claim 1, wherein said transparent panel is fabricated from plastics selected from the group comprising: polymethyl methacrylate (PMMA); polycarbonate (PC); polyethylene terephthalate (PET); and polyethersulfone (PES).

7. The window insert of claim 2, wherein said transparent panel is fabricated from plastics selected from the group comprising: polymethyl methacrylate (PMMA); polycarbonate (PC); polyethylene terephthalate (PET); and polyethersulfone (PES).

8. The window insert of claim 1, wherein the plurality of releasable fasteners is selected from the group comprising: double sided sticky tape; double sided sticky foam pads or tape; sticky-backed hook and loop fasteners; opposing cooperating sections of pop rivets or push/friction fit clips; and various non-mechanical fasteners.

9. The window insert of claim 2, wherein the plurality of releasable fasteners is selected from the group comprising: double sided sticky tape; double sided sticky foam pads or tape; sticky-backed hook and loop fasteners; opposing cooperating sections of pop rivets or push/friction fit clips; and various non-mechanical fasteners.

10. The window insert of claim 1, wherein the void cut out of said transparent panel is bayonetted.

11. The window insert of claim 2, wherein the void cut out of said transparent panel is bayonetted.

12. The window insert of claim 1, wherein a gasket surrounds the void cut out of said transparent panel.

13. The window insert of claim 2, wherein a gasket surrounds the void cut out of said transparent panel.

14. A kit for installing a mobile or stand-up A/C unit in a casement or awning window, said kit comprising:
a transparent panel having a perimeter and being sized and configured to attach to a frame of said casement or awning window or an insect screen installed in said casement or awning window;
a void cut out of said transparent panel, said void being sized and configured to cooperated with a vent hose of a mobile or stand-up A/C unit, and
a plurality of releasable fasteners.

15. The kit of claim 14, wherein a panel frame surrounds said perimeter of said transparent panel.

16. The kit of claim 14, having one or more additional voids cut out of said transparent panel, said one or more additional voids corresponding in shape and size to a crank handle and locking mechanism of said window.

17. The kit of claim 14, wherein said transparent panel is fabricated from plastics selected from the group comprising: polymethyl methacrylate (PMMA); polycarbonate (PC); polyethylene terephthalate (PET); and polyethersulfone (PES).

18. The kit of claim 14, wherein the plurality of releasable fasteners is selected from the group comprising: double sided sticky tape; double sided sticky foam pads or tape; sticky-backed hook and loop fasteners; opposing cooperating sections of pop rivets or push/friction fit clips; and various non-mechanical fasteners.

19. The kit of claim 14, wherein the void cut out of said transparent panel is bayonetted.

20. A method of installing a transparent window insert having A/C hose void in a casement or awning window, said window having a framed insect screen, said method comprising:
affixing a plurality of releasable fasteners positioned at intervals around perimeter of said transparent window insert or said frame of said insect screen;
positioning said transparent window insert against said frame of said insect screen, said transparent window insert being sized and configured to correspond with said frame of said insect screen;
attaching said transparent window insert to said frame of said insect screen via said plurality of releasable fasteners; and
connecting an A/C hose to said A/C hose void in said transparent window insert.
